(19) United States
(12) Patent Application Publication
(10) Pub. No.: US 2025/0349237 A1
(43) Pub. Date: Nov. 13, 2025

(54) MURA COMPENSATION MODULE, DISPLAY CONTROL APPARATUS INCLUDING SAME, AND MURA COMPENSATION METHOD USING THE SAME

(71) Applicant: LX SEMICON CO., LTD., Daejeon (KR)

(72) Inventors: Jun Young PARK, Daejeon (KR); Young Kyun KIM, Daejeon (KR); Gang Won LEE, Daejeon (KR); Min Ji LEE, Daejeon (KR)

(73) Assignee: LX SEMICON CO., LTD., Daejeon (KR)

(21) Appl. No.: 18/870,595

(22) PCT Filed: May 26, 2023
(86) PCT No.: PCT/KR2023/007316

§ 371 Date: Nov. 29, 2024

(30) Foreign Application Priority Data
May 30, 2022 (KR) 10-2022-0066223
Jan. 17, 2023 (KR) 10-2023-0006803

(51) Int. Cl. G09G 3/20; G09G 3/3225

(52) U.S. Cl. CPC G09G 3/2007; G09G 3/3225; G09G 2320/0233; G09G 2320/0242; G09G 2320/0673; G09G 2320/0693; G09G 2330/10; G09G 2360/145

(57) ABSTRACT

A Mura compensation module includes a DBV setting unit for setting one of a plurality of luminance bands as a set luminance band; a memory storing a reference Mura compensation value for each grayscale from a reference luminance band;, and a Mura compensation value determination unit for determining an input Mura compensation value of a first input grayscale value in the set luminance band, on the basis of the reference Mura compensation value for each grayscale from the reference luminance band.

### CROSS-REFERENCE TO RELATED APPLICATIONS

This application is a national phase entry of PCT International Application No. PCT/KR2023/007316 filed on May 26, 2023, which claims the priorities of Korean Application Nos. 10-2022-0066223 filed on May 30, 2022 and 10-2023-0006803 filed on Jan. 17, 2023, which are hereby incorporated by reference in their entirety.

### BACKGROUND

### Field of the Disclosure

The present disclosure relates to a mura compensation module, a display control apparatus including the same, and a method of compensating for mura using the same.

### Description of the Background

With the development of the information society, the demand for display devices for displaying images is increasing in various forms, and recently, various display devices such as liquid crystal display devices (LCDs) and organic light-emitting display devices (OLEDs) are being used.

A display device includes a plurality of pixels to display images, and luminance deviation or color deviation may occur in some of the plurality of pixels due to errors or manufacturing defects in a manufacturing process. Accordingly, mura in the form of a spot may be generated in the display device.

In a display device, compensation data for compensating for mura may be stored in a memory. In this case, since compensation data which is different according to a display brightness should be stored for accurate mura compensation, there is a problem that the capacity of a memory should be increased.

### SUMMARY

The present disclosure is intended to solve the above-described problems and directed to providing a mura compensation module capable of accurately compensating for mura according to a display brightness, a display control apparatus including the same, and a method of compensating for mura using the same.

In addition, the present disclosure is directed to providing a mura compensation module in which the capacity of a memory is reduced, a display control apparatus including the same, and a method of compensating for mura using the same.

One aspect of the present disclosure to achieve the above-described objects provides a mura compensation module including a DBV setting unit configured to set one of a plurality of luminance bands to a set luminance band; a memory configured to store reference a mura compensation value for each gray scale in a reference luminance band; and a mura compensation value determination unit configured to determine an input mura compensation value of a first input gray scale value in the set luminance band on the basis of the reference mura compensation value for each gray scale in the reference luminance band.

Another aspect of the present disclosure to achieve the above-described objects provides a display control apparatus including a pre-processor configured to generate gray scale data including a first input gray scale value for each of a plurality of pixels on the basis of image data; a mura compensation module configured to determine an input mura compensation value of each of the plurality of pixels using a reference mura compensation value in a reference luminance band and the first input gray scale values of the plurality of pixels included in the gray scale data; an image data conversion unit configured to convert the image data into image data in which the input mura compensation value is reflected with respect to each of the plurality of pixels; and an image data output unit configured to output the converted image data.

Still another aspect of the present disclosure to achieve the above-described objects provides a method of compensating for mura using a mura compensation module, comprising: setting one of a plurality of luminance bands to a set luminance band; obtaining a first input gray scale value for each of a plurality of pixels on the basis of image data; determining a first reference gray scale value in a reference luminance band that corresponds to the first input gray scale value and obtaining a reference mura compensation value for the first reference gray scale value in the reference luminance band from a memory; and determining an input mura compensation value for the first input gray scale value in the set luminance band using the reference mura compensation value.

According to the present disclosure, a mura compensation value may be changed based on a display brightness value. Accordingly, in the present disclosure, mura may be accurately compensated for even when the display brightness value is changed.

In addition, in the present disclosure, although mura may be compensated for according to a display brightness value, only reference mura compensation values for each gray scale in one reference luminance band may be stored in a memory. In the present disclosure, an input mura compensation value in a set luminance band may be determined using reference mura compensation values for each gray scale in a reference luminance band. Accordingly, in the present disclosure, since there is no need to extract mura compensation values for each gray scale in each luminance band, a tact time of a display device may be significantly reduced.

In addition, in the present disclosure, since mura compensation values for each gray scale do not need to be stored for each luminance band, the capacity of a memory may be significantly reduced.

### BRIEF DESCRIPTION OF THE DRAWINGS

The accompanying drawings, which are included to provide a further understanding of the disclosure and are incorporated in and constitute a part of the disclosure, illustrate aspects of the disclosure and together with the description serve to explain the principle of the disclosure.

In the drawings:

FIG. 1 is a block diagram illustrating a display device according to one aspect of the present disclosure;

FIG. 2 is a block diagram illustrating one example of a configuration of a timing controller illustrated in FIG. 1;

FIG. 3 is a block diagram illustrating one example of a configuration of a mura compensation value determination unit of FIG. 2;

FIG. 4 is a view illustrating one example of a target luminance value and an actual luminance value of a mura pixel according to a 2.2 gamma curve;

FIG. 5 is a view illustrating one example of mura compensation values for each gray scale;

FIG. 6A is a view illustrating one example of one 2.2 gamma curve in a plurality of luminance bands;

FIG. 6B is a view illustrating one example of another 2.2 gamma curve in the plurality of luminance bands;

FIG. 7 is a view for describing one example in which a reference gray scale value determination unit of FIG. 3 determines a first reference gray scale value;

FIG. 8 is a view for describing one example in which an input mura compensation value determination unit of FIG. 3 determines an input mura compensation value;

FIG. 9 is a flowchart for describing a method of compensating for mura using a mura compensation module according to one aspect of the present disclosure; and

FIG. 10 is a flowchart for describing a method of determining an input mura compensation value.

Like reference numerals refer to substantially the same elements throughout the specification. In the following description, detailed description of components which are not related to core components of the present disclosure and components and functions which are known in the art of the present disclosure may be omitted. Meanings of terms described in this specification should be understood as follows.

### DETAILED DESCRIPTION

Advantages and features of the present disclosure and methods of achieving the same will become apparent with reference to the accompanying drawings and the following detailed aspects. However, the present disclosure is not limited to aspects to be disclosed below but may be implemented in various different forms, the aspects are provided so that the present disclosure is completely implemented and provided to fully explain the scope of the present disclosure for those skilled in the art, and the scope of the present disclosure is defined by the appended claims.

Like reference numerals refer to like elements throughout the specification. In addition, in the description of the present disclosure, certain detailed descriptions of the related art are omitted when they are deemed to unnecessarily obscure the gist of the disclosure.

When the terms “comprise,” “include,” have,” “be formed of,” and the like are used in the present specification, other elements may be added thereto unless “only” is used. A case in which a component is expressed in a singular form includes a case in which the component is provided as a plurality of components unless otherwise explicitly stated.

In the case of time-related description, for example, a case in which temporal parts are described with “after,” “before,” or the like may include a case in which the temporal parts are not sequential unless the term “immediately” or “directly” is used.

Although terms such as “first,” “second,” and the like may be used for describing various elements, the elements are not limited by the terms. The terms are only used to distinguish one element from another element. Accordingly, a first element to be mentioned below may also be a second element in a technical spirit of the present disclosure.

The term “at least one” should be understood to include all possible combinations from one or more related items. For example, “at least one of a first item, a second item, and a third item” may mean not only the first item, the second item, or the third item, but also all possible combinations of two or more items among the first item, second item, and the third item.

Features of various aspects of the present disclosure may be partially or entirely coupled or combined and driven in cooperation in various technical ways, and the aspects may also be implemented independently of each other or implemented together in conjunction with each other.

Hereinafter, aspects of the present specification will be described in detail with reference to the accompanying drawings.

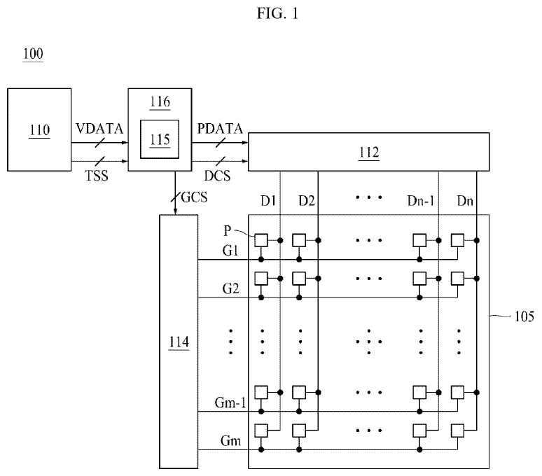

FIG. 1 is a block diagram illustrating a display device according to one aspect of the present disclosure.

A display device 100 according to one aspect of the present disclosure may be a device functioning as a display and implemented as a flat display device such as a liquid crystal display (LCD) device or organic light emitting diode (OLED) device.

As illustrated in FIG. 1, the display device 100 according to the present disclosure includes a host system 110, a display panel 105, and a display driving device for driving the display panel 105.

The display panel 105 includes a display region in which a plurality of pixels P are provided to display an image. The display panel 105 includes a plurality of data lines D1 to Dn (n is a positive integer greater than or equal to 2), a plurality of gate lines G1 to Gm (m is a positive integer greater than or equal to 2), and the plurality of pixels P.

Each of the plurality of data lines DI to Dn receives a data signal. Each of the plurality of gate lines G1 to Gm receives a gate signal. The plurality of data lines DI to Dn and the plurality of gate lines G1 to Gm are provided on a substrate to intersect each other and define the plurality of pixels P. Each of the plurality of pixels P may be connected to any one of the plurality of data lines DI to Dn and any one of the plurality of gate lines G1 to Gm. Each of the plurality of pixels P may include a driving transistor, a scan transistor which is turned on by a gate signal of the gate line to supply a data voltage of the data line to a gate electrode of the driving transistor, an OLED which emits light according to a drain-source current of the driving transistor, and a capacitor for storing the voltage of the gate electrode of the driving transistor. Accordingly, each of the plurality of pixels P may emit light according to a current supplied to the OLED.

The display driving device may supply the data signals to the plurality of pixels P included in the display panel 105 to display an image through the display panel 105, To this end, the display driving device may include a data driving unit 112, a gate driving unit 114, and a timing controller 116.

The data driving unit 112 receives pixel data PDATA and a data control signal DCS from the timing controller 116.

In one aspect, the data driving unit 112 may receive a clock embedded data signaling (CEDS) packet from the timing controller 116 and obtain a clock signal, the data control signal DCS, and the pixel data PDATA from the CEDS packet. In this case, the CEDS packet may be a packet in the form in which clocks of data are embedded.

Hereinafter, it will be illustrated that the data driving unit 112 receives the CEDS pack including the pixel data PDATA and the data control signal DCS from the timing controller 116 for the sake of convenience in the description, but the present disclosure is not necessarily limited thereto. The data driving unit 112 may receive each of the pixel data PDATA and the data control signal DCS from the timing controller 116.

The data driving unit 112 converts the pixel data PDATA into an analog positive/negative data signal according to the data control signal DCS and supplies the analog positive/negative data signal to the pixels P through the plurality of data lines DI to Dn.

The gate driving unit 114 receives a gate control signal GCS from the timing controller 116. The gate driving unit 114 supplies gate signals to the plurality of gate lines G1 to Gm according to the gate control signal GCS.

Specifically, the gate driving unit 114 generates the gate signal (or scan signal) synchronized with the data signal and sequentially supplies the generated gate signal to the gate lines G1 to Gm while shifting according to control of the timing controller 116. To this end, the gate driving unit 114 may include a plurality of gate drive integrated circuits (ICs, not shown). The gate drive ICs may select a data line to which the data signal is applied by sequentially supplying the gate signal synchronized with the data signal to the plurality of gate lines G1 to Gn according to the control of the timing controller 116. The gate signal may swing between a gate high-voltage and a gate low-voltage.

The timing controller 116 receives digital video data VDATA and timing signals TSS from the host system 110. The timing signals TSS may include a reference clock signal (for example, a dot clock), a vertical synchronization signal, a horizontal synchronization signal, a data enable signal, and the like. The vertical synchronization signal is a signal which defines one frame period. The horizontal synchronization signal is a signal which defines one horizontal period needed to supply the data signals to the pixels P of one horizonal line of the display panel 105. The data enable signal is a signal which defines a period in which effective data is input. The dot clock is a signal which repeats with a predetermined short cycle.

The timing controller 116 may include a data processor (not shown) which generates the pixel data PDATA, the data control signal DCS, and the gate control signal GCS using the digital video data VDATA and the timing signals TSS.

The data processor of the timing controller 116 may generate the data control signal DCS to control an operation timing of the data driving unit 112 and the gate control signal GCS to control an operation timing of the gate driving unit 114 on the basis of the timing signals TSS to control the operation timings of the data driving unit 112 and the gate driving unit 114.

The data processor of the timing controller 116 may convert the digital video data VDATA to the pixel data PDATA by arranging the digital video data VDATA to match with a pixel structure formed in the display panel 105. As an example, the data processor may convert digital video data VDATA for 3 colors (red, green, and blue) using a predetermined conversion method to be arranged as pixel data PDATA for 4 colors (white, red, green, and blue). In addition, the data processor may also correct the pixel data PDATA through various image processing such as image quality compensation, external compensation, degradation compensation, and mura compensation.

Particularly, the display device 100 according to one aspect of the present disclosure includes a mura compensation module 115 for mura compensation. As illustrated in FIG. 1, the mura compensation module 115 may be included in the timing controller 116 but is not necessarily limited thereto. In another aspect, a mura compensation module 115 may be included in another display control apparatus instead of a timing controller 116 or be a separate independent component. However, hereinafter, it will be illustrated that the mura compensation module 115 is included in the timing controller 116 for the sake of convenience in the description, the present disclosure is not limited thereto.

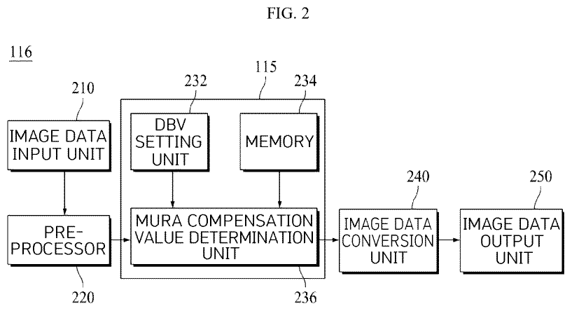

The mura compensation module 115 may determine a mura compensation value of each of the plurality of pixels on the basis of the digital video data VDATA for each frame and provide the mura compensation values for each of the plurality of pixels to the data processor of the timing controller 116. The data processor of the timing controller 116 may correct the pixel data PDATA according to the mura compensation values for each of the plurality of pixels. The mura compensation module 115 will be described in detail with reference to FIGS. 2 to 8.

The timing controller 116 outputs the pixel data PDATA and the data control signal DCS to the data driving unit 112 and outputs the gate control signal GCS to the gate driving unit 114 for a display driving period.

The host system 110 converts the digital video data VDATA to data in a format that is suitably displayed on the display panel 105. The host system 110 transmits the timing signals TSS to the timing controller 116 with the digital video data VDATA. The host system 110 may be implemented as any one of a television system, a set-top box, a navigation system, a digital versatile disc (DVD) player, a blu-ray player, an electronic board, a kiosk system, a personal computer (PC), a home theater system, and a phone system and receive an input image.

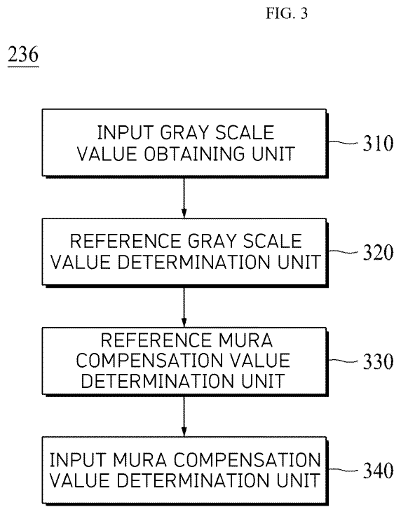

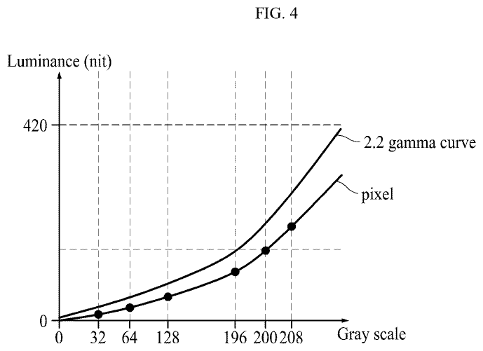

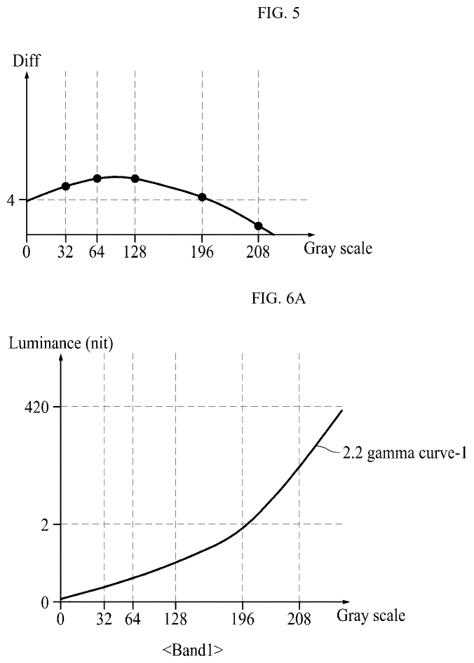

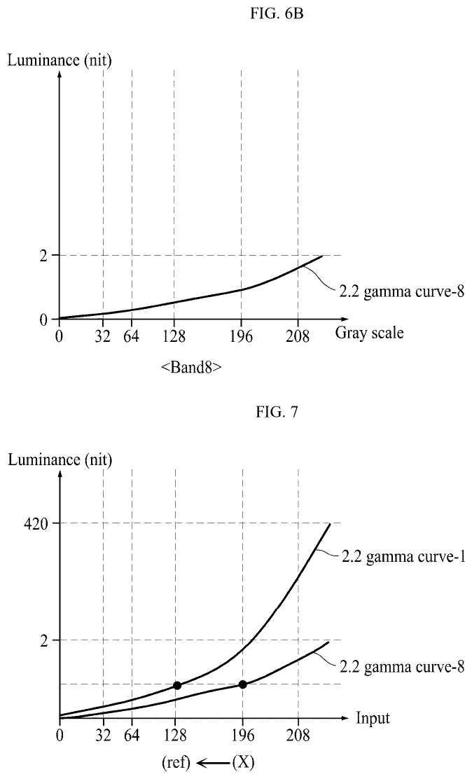

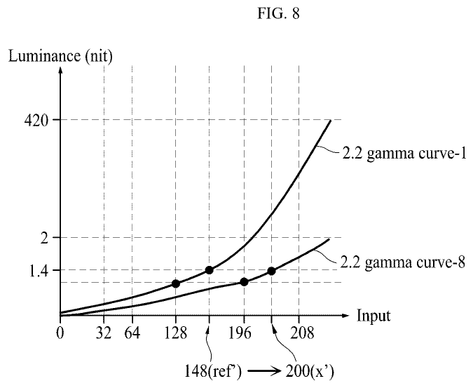

FIG. 2 is a block diagram illustrating one example of a configuration of the timing controller illustrated in FIG. 1, and FIG. 3 is a block diagram illustrating one example of a configuration of a mura compensation value determination unit of FIG. 2. FIG. 4 is a view illustrating one example of a target luminance value and an actual luminance value of a mura pixel according to a 2.2 gamma curve, and FIG. 5 is a view illustrating one example of a mura compensation value of each gray scale. FIG. 6A is a view illustrating one example of one 2.2 gamma curve in a plurality of luminance bands, and FIG. 6B is a view illustrating one example of another 2.2 gamma curve in the plurality of luminance bands. FIG. 7 is a view for describing one example in which a reference gray scale value determination unit of FIG. 3 determines a first reference gray scale value, and FIG. 8 is a view for describing one example in which an input mura compensation value determination unit of FIG. 3 determines an input mura compensation value.

Referring to FIG. 2, the timing controller 116 according to one aspect of the present disclosure may include an image data input unit 210, the mura compensation module 115, an image data conversion unit 240, and an image data output unit 250. In FIG. 2, it is illustrated that the timing controller 116 includes the mura compensation module 115, but the present disclosure is not necessarily limited thereto.

In another aspect, a mura compensation module 115 may be included in another display control apparatus rather than a timing controller 116 or included in a data driving device as a separate independent component. In this case, the mura compensation module 115 may determine a mura compensation value of each of a plurality of pixels on the basis of digital video data VDATA received from a host system 110 and provide the determined mura compensation value of each of the plurality of pixels to the timing controller 116.

Hereinafter, it will be described that the mura compensation module 115 is included in the timing controller 116 for the sake of convenience in the description.

First, the image data input unit 210 receives a digital video data VDATA from the host system 110 and transmits the received digital video data VDATA to a pre-processor 220.

The pre-processor 220 pre-processes the digital video data VDATA to obtain a gray scale value of each of the plurality of pixels. Hereinafter, the gray scale value of each of the plurality of pixels obtained from the pre-processor 220 will be called a first input gray scale value for the sake of convenience in the description.

The digital video data VDATA may include image data of a plurality of frames. The pre-processor 220 may pre-process the image data for each frame.

Meanwhile, the image data may include a red-green-blue (RGB) pixel value of each of the plurality of pixels. The pre-processor 220 may obtain the first input gray scale value using the RGB pixel value of each of the plurality of pixels included in the image data.

The pre-processor 220 may generate gray scale data including the first input gray scale value of each of the plurality of pixels obtained on the basis of the image data and provide the generated gray scale data to the mura compensation module 115.

The mura compensation module 115 determines a mura compensation value for the first input gray scale value of the plurality of pixels according to a set display brightness. In this case, the mura compensation value is a compensation value for obtaining a target luminance value when the pixel has a luminance value different from the target luminance value.

Specifically, for example, a target luminance value of each gray scale may match with a 2.2 gamma curve as illustrated in FIG. 4. The plurality of pixels included in the display panel 105 may have a luminance value of each gray scale matching with the 2.2 gamma curve.

However, some pixels included in the display panel 105 may have a luminance value of each gray scale which is different from that of the 2.2 gamma curve as illustrated in FIG. 4. In this case, the corresponding pixel may have a luminance smaller than surrounding pixels even when receiving the same gray scale value, and then, mura in the form of a spot may generated.

The mura compensation value may be applied to the gray scale value of the pixel, in which mura is generated, so that the pixel having the generated mura has the target luminance value of each gray scale. That is, the luminance value of the pixel in which the mura is generated may be increased or decreased to the target luminance value matching with that of the 2.2 gamma curve by increasing or decreasing the gray scale value of the pixel, in which the mura is generated, by the mura compensation value. In this case, a mura compensation value Diff may vary for each gray scale as illustrated in FIG. 5.

Meanwhile, the 2.2 gamma curve may vary depending on a display brightness, and accordingly, the mura compensation value Diff may also vary depending on the display brightness.

The mura compensation module 115 may determine a mura compensation value for a first input gray scale value at a set display brightness using a reference mura compensation value. Hereinafter, the mura compensation value for the first input gray scale value is called an input mura compensation value for the sake of convenience in the description.

The mura compensation module 115 determines an input mura compensation value of each of the plurality of pixels using a reference mura compensation value in a reference luminance band and the first input gray scale values of the plurality of pixels included in gray scale data. To this end, the mura compensation module 115 includes a display brightness value (DBV) setting unit 232, a memory 234, and a mura compensation value determination unit 236.

The DBV setting unit 232 sets one of a plurality of luminance bands as a set luminance band. In the DBV setting unit 232, the set luminance band may be determined by the host system 110 on the basis of a user command received through a user interface connected to the host system 110 or a sensor value obtained through various sensors such as an illuminance sensor.

The plurality of luminance bands may be distinguished according to a DBV. The plurality of luminance bands may correspond to different DBVs. In this case, the DBV may denote a brightness corresponding to a maximum gray scale value of pixel data, for example, a gray scale value of 255 in the case of 8-bit data.

The number of the plurality of luminance bands may be preset. For example, the luminance bands may be divided into 19 luminance bands Band1 to Band19. A first luminance band Band1 may correspond to a DBV corresponding to a maximum luminance value of the display panel 105. A nineteenth luminance band Band19 may correspond to a relatively low DBV but is not necessarily limited thereto. It may be designed oppositely.

In each of the plurality of luminance bands, a 2.2 gamma curve in which a corresponding DBV is a target luminance value of a maximum gray scale may match with a target luminance value of each gray scale. For example, in the first luminance band Band1, a DBV may correspond to 420 which is a maximum luminance value of the display panel 105. In this case, the first luminance band Band1 may match with a 2.2 gamma curve (2.2 gamma curve-1) in which a target luminance value of each gray scale is 420 at a maximum gray scale value of 255 as illustrated in FIG. 6A. Meanwhile, in an eighth luminance band Band8, a DBV may correspond to 2. In this case, the eighth luminance band Band8 may match with a 2.2 gamma curve (2.2 gamma curve-8) in which a target luminance value of each gray scale is 2 at a maximum gray scale value of 255 as illustrated in FIG. 6B.

When one of the plurality of luminance bands is set as the set luminance band, the DBV setting unit 232 may provide information on the set luminance band to the mura compensation value determination unit 236. In one aspect, the DBV setting unit 232 may output a DBV corresponding to the set luminance band to the mura compensation value determination unit 236.

The memory 234 stores mura compensation values for each gray scale in the reference luminance band. The memory 234 may be a device for storing data and may be a flash memory.

Hereinafter, the mura compensation value in the reference luminance band is called a reference mura compensation value for the sake of convenience in the description. The reference mura compensation value may be a mura compensation value of each gray scale in the reference luminance band and may be distinguished from the input mura compensation value which is the mura compensation value for the input gray scale value in the set luminance band.

The memory 234 stores only reference mura compensation values for each gray scale in one specific luminance band, that is, the reference luminance band. In this case, the reference luminance band may be one of the plurality of luminance bands. As an example, the reference luminance band may be the first luminance band Band1 but is not necessarily limited thereto. As another example, a reference luminance band may be a tenth luminance band Band10.

The reference mura compensation values for each gray scale in the reference luminance band stored in the memory 234 may be obtained using a separate mura test system. The mura test system may obtain the reference mura compensation value by analyzing an image obtained by capturing an image of the display panel 105 displaying a test image using a camera.

Specifically, the mura test system may sequentially display test images for each gray scale on the display panel 105. In this case, a test image displayed on the display panel 105 may correspond to an image for each gray scale in a reference luminance band. The test images displayed on the display panel 105 may include images for all gray scales but are not necessarily limited thereto. The test images displayed on the display panel 105 may include only images for some of the gray scales in an entire range to reduce a test time and the capacity of the memory 234. As an example, the test images displayed on the display panel 105 may include only images for 32 gray, 64 gray, 128 gray, 196 gray, 208 gray, and 255gray.

Meanwhile, the mura test system may capture the test image for each gray scale displayed on the display panel 105 using the camera. The mura test system may determine a reference mura compensation value by analyzing the image obtained from the camera. Specifically, the mura test system may determine the reference mura compensation value based on a gray scale value input to the display panel 105 and a luminance value of the image obtained from the camera.

In one aspect, the mura test system may obtain reference mura compensation values for each of the plurality of pixels by comparing a target luminance value of a gray scale value input to the plurality of pixels of the display panel 105 and a luminance value of the plurality of pixels of an image obtained from the camera. The target luminance value may correspond to a luminance value of each gray scale matching with a 2.2 gamma curve corresponding to a reference luminance band.

The plurality of pixels included in the display panel 105 may be displayed with a target luminance value matching with the 2.2 gamma curve corresponding to the reference luminance band when receiving a specific gray scale value but may be displayed with a luminance value different from the target luminance values due to errors or manufacturing defects in a manufacturing process. A luminance deviation between the target luminance value and the luminance value of the image obtained from the camera for each of the plurality of pixels may be measured, and a reference mura compensation value may be determined based on the luminance deviation. The reference mura compensation value may correspond to a gray scale compensation value for eliminating the luminance deviation. That is, the reference mura compensation value may correspond to the gray scale compensation value for allowing the luminance value in the image obtained from the camera to be the same as the target luminance value.

In the above aspect, it is illustrated that the mura test system obtains the reference mura compensation values for each of the plurality of pixels, but the present disclosure is not necessarily limited thereto. The mura test system may also obtain reference mura compensation values for each of a plurality of blocks to reduce a test time and the capacity of the memory 234. The plurality of pixels included in the display panel 105 may be divided into the plurality of blocks. Each of the plurality of blocks may correspond to at least one pixel. As an example, each of the plurality of blocks may include pixels arrayed in the matrix form of N×N. In this case, N is a natural number greater than one.

When the reference mura compensation values for each gray scale in the reference luminance band are determined for each of the plurality of pixels or each of the plurality of blocks, the mura test system may store the reference mura compensation values for each gray scale in the memory 234.

The mura compensation module 115 according to one aspect of the present disclosure stores only the reference mura compensation values for each gray scale in one reference luminance band in the memory 234. The mura compensation module 115 according to one aspect of the present disclosure may determine an input mura compensation value for a first input gray scale value in a set luminance band using the reference mura compensation values for each gray scale in the reference luminance band. Since the mura compensation module 115 according to one aspect of the present disclosure does not need to extract or store mura compensation values for each gray scale for each luminance band, a tact time of the display device 100 and the capacity of the memory 234 may be significantly reduced.

The mura compensation value determination unit 236 determines the input mura compensation value of each of the plurality of pixels in the set luminance band using the reference mura compensation value in the reference luminance band stored in the memory 234 and the first input gray scale values of the plurality of pixels included in gray scale data. In addition, when the DBV setting unit 232 outputs a DBV, the mura compensation value determination unit 236 may determine an input mura compensation value of each of the plurality of pixels in the set luminance band using a display brightness value, the reference mura compensation value in the reference luminance band, and the first input gray scale values of the plurality of pixels included in the gray scale data.

To this end, as illustrated in FIG. 3, the mura compensation value determination unit 236 may include an input gray scale value obtaining unit 310, a reference gray scale value determination unit 320, a reference mura compensation value determination unit 330, and an input mura compensation value determination unit 340.

The input gray scale value obtaining unit 310 may obtain a first input gray scale value from the pre-processor 220. Specifically, the input gray scale value obtaining unit 310 may obtain the first input gray scale values for each of the plurality of pixels from the pre-processor 220.

The reference gray scale value determination unit 320 determines a first reference gray scale value in a reference luminance band that corresponds to the first input gray scale value. Specifically, the reference gray scale value determination unit 320 may determine the first reference gray scale value in the reference luminance band that corresponds to the first input gray scale value in a set luminance band for each of the plurality of pixels. The reference gray scale value determination unit 320 may determine a gray scale value in the reference luminance band having a luminance the same as that of the first input gray scale value in the set luminance band as the first reference gray scale value.

For example, a reference luminance band may correspond to the first luminance band Band1, and a target luminance value of each gray scale may have that along the 2.2 gamma curve (2.2 gamma curve-1) as illustrated in FIG. 6A. A set luminance band may correspond to the eighth luminance band Band8, and the target luminance value of each gray scale may have that along the 2.2 gamma curve (2.2 gamma curve-8) as illustrated in FIG. 6B. In this case, when a first input gray scale value X is 196, a gray scale value having a luminance the same as that of 196 which is the first input gray scale value X in the set luminance band Band8 may be found in the reference luminance band Band1. As illustrated in FIG. 7, when the gray scale value having the luminance is the same as that of 196 which is the first input gray scale value X in the set luminance band Band8 is 128 in the reference luminance band Band1, the reference gray scale value determination unit 320 may determine a first reference gray scale value ref in the reference luminance band Band1 corresponding to 196 which is the first input gray scale value X in the set luminance band Band8 as 128.

The reference gray scale value determination unit 320 may determine the first reference gray scale value in the reference luminance band that corresponds to the first input gray scale value in the set luminance band using a first gain value in the set luminance band with respect to the reference luminance band. The first gain value may denote a ratio between a gray scale value in a corresponding luminance band and a gray scale value in a reference luminance band having a luminance the same as that of the gray scale value in the corresponding luminance band. The first gain value may be preset by comparing a 2.2 gamma curve in the corresponding luminance band with a 2.2 gamma curve in the reference luminance band. In addition, first gain values for each of the plurality of luminance bands may be stored in the memory 234. In one aspect, the first gain value may correspond to a DBV in each of the plurality of luminance bands and may be stored in the memory 234.

The reference gray scale value determination unit 320 may obtain the first gain value for the set luminance band from the memory 234 and determine the first reference gray scale value in the reference luminance band that corresponds to the first input gray scale value in the set luminance band on the basis of the obtained first gain value.

In one aspect, the reference gray scale value determination unit 320 may search for a DBV corresponding to a set luminance band in the memory 234 and obtain a first gain value corresponding to the retrieved DBV.

In one aspect, the reference gray scale value determination unit 320 may calculate a first reference gray scale value in a reference luminance band by multiplying a first input gray scale value by the obtained first gain value.

The reference mura compensation value determination unit 330 obtains a reference mura compensation value for a first reference gray scale value from the memory 234. Specifically, the reference mura compensation value determination unit 330 may obtain reference mura compensation values for each of the plurality of pixels. The memory 234 may store the reference mura compensation values for each gray scale of each of the plurality of pixels or each of the plurality of blocks. The reference mura compensation value determination unit 330 may search for a corresponding pixel or a block including the corresponding pixel in the memory 234. The reference mura compensation value determination unit 330 may determine a reference mura compensation value for a first reference gray scale value of the corresponding pixel on the basis of the reference mura compensation values for each gray scale corresponding to the retrieved pixel or the block.

The reference mura compensation value determination unit 330 may search for the reference mura compensation value corresponding to the first reference gray scale value among reference mura compensation values for gray scales stored in the memory 234. When a reference mura compensation value corresponding to the first reference gray scale value is searched for, the reference mura compensation value determination unit 330 may determine the retrieved reference mura compensation value as the reference mura compensation value for the first input gray scale value of the corresponding pixel. However, when a reference mura compensation value corresponding to the first reference gray scale value is not searched for, the reference mura compensation value determination unit 330 may calculate the reference mura compensation value for the first reference gray scale value on the basis of the reference mura compensation values for each gray scale stored in the memory 234.

As an example, the memory 234 may store only reference mura compensation values at 32 gray, 64 gray, 128 gray, 196 gray, 208 gray, and 255 gray. When a first reference gray scale value is 200 gray, the reference mura compensation value determination unit 330 cannot search for a reference mura compensation value corresponding to the 200 gray in the memory 234. In this case, the reference mura compensation value determination unit 330 may calculate a reference mura compensation value of the first reference gray scale value using the reference mura compensation values of at 196 gray and 208 gray which are gray scale values close to 200 gray which is the first reference gray scale value among the gray scale values stored in the memory 234. As an example, the reference mura compensation value determination unit 330 may determine a value between the reference mura compensation value at 196 gray and the reference mura compensation value at 208 gray as a reference mura compensation value at the first reference gray scale value at 200 gray using interpolation.

The input mura compensation value determination unit 340 determines an input mura compensation value at the first input gray scale value in the set luminance band on the basis of the reference mura compensation value. Specifically, the input mura compensation value determination unit 340 may determine the input mura compensation value of each of the plurality of pixels in the set luminance band on the basis the reference mura compensation values for each of the plurality of pixels obtained from the reference mura compensation value determination unit 330.

The input mura compensation value determination unit 340 may calculate a second reference gray scale value by reflecting the reference mura compensation value to the first reference gray scale value. In one aspect, the input mura compensation value determination unit 340 may determine a value of the first reference gray scale value plus the reference mura compensation value as the second reference gray scale value.

In addition, the input mura compensation value determination unit 340 may determine a second input gray scale value in the set luminance band that corresponds to the second reference gray scale value in the reference luminance band. The input mura compensation value determination unit 340 may determine a gray scale value in the set luminance band having a luminance the same as that of the second reference gray scale value in the reference luminance band as the second input gray scale value.

For example, a reference luminance band may correspond to the first luminance band Band1, and a target luminance value of each gray scale may have that along the 2.2 gamma curve-1 as illustrated in FIG. 6A. A set luminance band may correspond to the eighth luminance band Band8, and the target luminance value of each gray scale may have that along the 2.2 gamma curve-8 as illustrated in FIG. 6B. As illustrated in FIGS. 7 and 8, when a first reference gray scale value ref in the reference luminance band Band1 is 128, and a reference mura compensation value is 20, the input mura compensation value determination unit 340 may determine a second reference gray scale value ref′ as 140 and search for a gray scale value having a luminance the same as that of 140, which is the second reference gray scale value ref′ in the reference luminance band Band1, in the set luminance band Band8. As illustrated in FIG. 8, a gray scale value in the set luminance band Band8 having the luminance the same as that of 140, which is the second reference gray scale value ref in the reference luminance band Band1, is 200, the input mura compensation value determination unit 340 may determine a second input gray scale value X′ in the set luminance band Band8 corresponding to 140 which is the second reference gray scale value ref′ in the reference luminance band Band1 as 200.

The input mura compensation value determination unit 340 may determine the second input gray scale value in the set luminance band that corresponds to the second reference gray scale value in the reference luminance band using a second gain value in the set luminance band with respect to the reference luminance band. The second gain value may denote a ratio between a gray scale value in a reference luminance band and a gray scale value in a set luminance band having a luminance the same as that of the gray scale value in the reference luminance band. The second gain value may be preset by comparing a 2.2 gamma curve in a corresponding luminance band with a 2.2 gamma curve in the reference luminance band. In addition, second gain values for each of the plurality of luminance bands may be stored in the memory 234. In one aspect, the second gain value may correspond to a DBV in each of the plurality of luminance bands and may be stored in the memory 234.

The input mura compensation value determination unit 340 may obtain the second gain value in the set luminance band from the memory 234 and determine the second input gray scale value in the set luminance band that corresponds to the second reference gray scale value in the reference luminance band on the basis of the obtained second gain value.

In one aspect, the input mura compensation value determination unit 340 may search for a DBV corresponding to a set luminance band in the memory 234 and obtain a second gain value corresponding to the retrieved DBV.

In one aspect, the input mura compensation value determination unit 340 may calculate a second input gray scale value in the set luminance band by multiplying a second reference gray scale value by the obtained second gain value.

The input mura compensation value determination unit 340 may determine an input mura compensation value in the set luminance band on the basis of the first input gray scale value and the second input gray scale value. In one aspect, the input mura compensation value determination unit 340 may determine that a difference between the first input gray scale value and the second input gray scale value is the input mura compensation value for the first input gray scale value of a corresponding pixel.

The image data conversion unit 240 converts image data into image data in which the input mura compensation value is reflected. Specifically, the image data conversion unit 240 may receive image data from the image data input unit 210 or receive gray scale data including first input gray scale values for each of the plurality of pixels from the pre-processor 220. The image data conversion unit 240 may generate image data for which mura compensation is performed by reflecting input mura compensation values for each of the plurality of pixels determined by the mura compensation module 115 to the image data received from the image data input unit 210 or the gray scale data received from the pre-processor 220.

The image data output unit 250 may output the image data, in which the input mura compensation value of each of the plurality of pixels determined by the mura compensation module 115 is reflected, to the display panel 105.

The mura compensation module 115 according to one aspect of the present disclosure may accurately compensate mura even when a display brightness varies by changing a mura compensation value on the basis of a display brightness value.

In addition, the mura compensation module 115 according to one aspect of the present disclosure may store only reference mura compensation values for each gray scale in one reference luminance band in the memory 234 and determine an input mura compensation value for a first input gray scale value in a set luminance band using reference mura compensation values for each gray scale in the reference luminance band. Accordingly, since the mura compensation module 115 according to one aspect of the present disclosure does not need to extract and store mura compensation values for each gray scale in each luminance band, a tact time of the display device 100 and the capacity of the memory 234 may be significantly reduced.

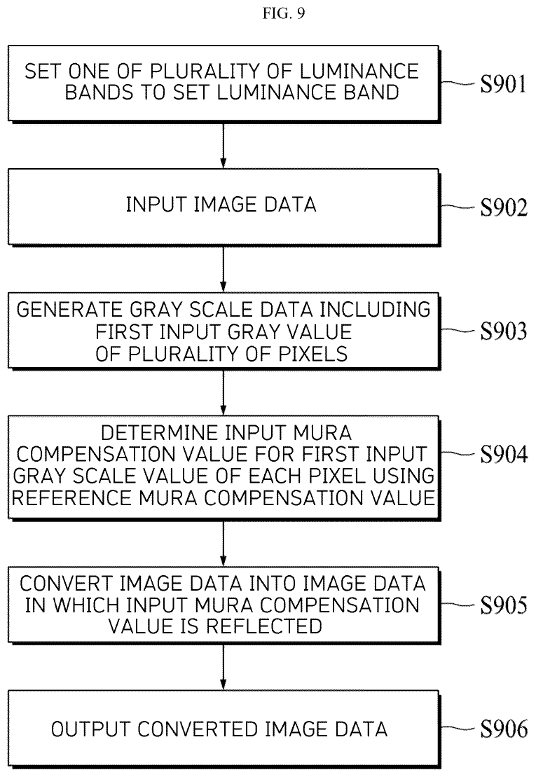

FIG. 9 is a flowchart for describing a method of compensating for mura using the mura compensation module according to one aspect of the present disclosure.

Referring to FIG. 9, first, the display device 100 sets one of a plurality of luminance bands as a set luminance band (S901).

In the display device 100, the set luminance band may be determined by the host system 110 on the basis of a user command received from the user through the user interface connected to the host system 110 or a sensor value obtained from various sensors such as the luminance sensor.

When one of the plurality of luminance bands is set as the set luminance band, the display device 100 may provide information on the set luminance band to the mura compensation module 115. In one aspect, the display device 100 may provide a DBV corresponding to the set luminance band to the mura compensation module 115.

Then, when image data is input from the outside, the display device 100 generates gray scale data including first input gray scale values for each of the plurality of pixels on the basis of the image data (S902 and S903).

When the image data is input from the outside, the display device 100 may obtain the first input gray scale values for each of the plurality of pixels by pre-processing the image data. In one aspect, the display device 100 may obtain the first input gray scale value using a RGB pixel value of each of the plurality of pixels included in the image data.

The display device 100 may generate the gray scale data including the first input gray scale values for each of the plurality of pixels obtained on the basis the image data and provide the generated gray scale data to the mura compensation module 115.

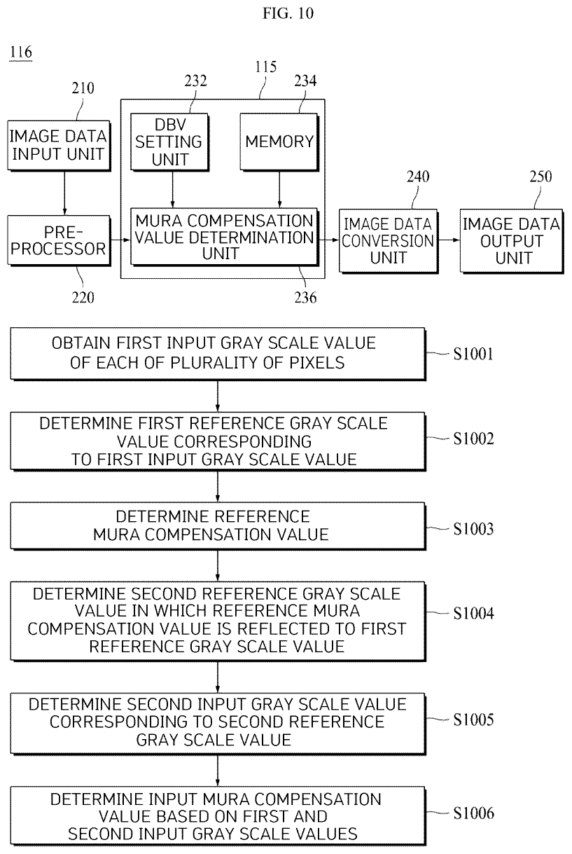

Then, the display device 100 determines an input mura compensation value for the first input gray scale value of each of the plurality of pixels using the mura compensation module 115 (S904). Hereinafter, a method of determining the input mura compensation value will be specifically described with reference to FIG. 10.

FIG. 10 is a flowchart for describing a method of determining an input mura compensation value.

Referring to FIG. 10, first, the mura compensation module 115 obtains a first input gray scale value of each of the plurality of pixels from gray scale data (S1001).

Then, the mura compensation module 115 determines a first reference gray scale value in a reference luminance band that corresponds to the first input gray scale value (S1002).

Specifically, the mura compensation module 115 may determine the first reference gray scale value in the reference luminance band that corresponds to the first input gray scale value of each of the plurality of pixels in a set luminance band. The mura compensation module 115 may determine a gray scale value in the reference luminance band having a luminance the same as that of the first input gray scale value in the set luminance band as the first reference gray scale value.

In one aspect, the mura compensation module 115 may determine the first reference gray scale value in the reference luminance band that corresponds to the first input gray scale value in the set luminance band using a first gain value in the set luminance band with respect to the reference luminance band. The first gain value may denote a ratio between a gray scale value in a corresponding luminance band and a gray scale value in the reference luminance band having a luminance the same as that of the gray scale value in the corresponding luminance band. The first gain value may be preset by comparing a 2.2 gamma curve in the corresponding luminance band with a 2.2 gamma curve in the reference luminance band. In addition, first gain values for each of the plurality of luminance bands may be stored in the memory 234. In one aspect, the first gain value may correspond to a DBV in each of the plurality of luminance bands and may be stored in the memory 234.

The mura compensation module 115 may obtain the first gain value in the set luminance band from the memory 234 and determine the first reference gray scale value in the reference luminance band that corresponds to the first input gray scale value in the set luminance band on the basis of the obtained first gain value. In one aspect, the mura compensation module 115 may calculate the reference gray scale value in the reference luminance band by multiplying the first input gray scale value by the obtained first gain value.

Then, the mura compensation module 115 determines a reference mura compensation value for the first reference gray scale value (S1003).

The mura compensation module 115 may obtain the reference mura compensation values for each of the plurality of pixels. The memory 234 of the display device 100 may store reference mura compensation values for each gray scale with respect to each of the plurality of pixels or each of the plurality of blocks. The mura compensation module 115 may search for a corresponding pixel or a block including the corresponding pixel in the memory 234 and determine the reference mura compensation value for the first reference gray scale value of the corresponding pixel on the basis of the reference mura compensation values for each gray scale corresponding to the retrieved pixel or block.

The mura compensation module 115 may search for the reference mura compensation value corresponding to the first reference gray scale value among reference mura compensation values for gray scales stored in the memory 234. When the reference mura compensation value corresponding to the first reference gray scale value is searched for, the mura compensation module 115 may determine the retrieved reference mura compensation value as the reference mura compensation value for the first input gray scale value of the corresponding pixel. However, when the reference mura compensation value corresponding to the first reference gray scale value is not searched for, the mura compensation module 115 may calculate the reference mura compensation value for the first reference gray scale value by performing an interpolation based on the reference mura compensation values for each gray scale stored in the memory 234.

Then, the mura compensation module 115 determines that a second reference gray scale value in which the reference mura compensation value is reflected is the first reference gray scale value (S1004). In one aspect, the mura compensation module 115 may determine a value of the first reference gray scale value plus the reference mura compensation value as the second reference gray scale value.

Then, the mura compensation module 115 determines a second input gray scale value in the set luminance band that corresponds to the second reference gray scale value in the reference luminance band (S1005).

Specifically, the mura compensation module 115 may determine the second input gray scale value in the set luminance band that corresponds to the second reference gray scale value in the reference luminance band for each of the plurality of pixels. The mura compensation module 115 may determine a gray scale value in the set luminance band having a luminance the same as that of the second reference gray scale value in the reference luminance band as the second input gray scale value.

The mura compensation module 115 may determine the second input gray scale value in the set luminance band that corresponds to the second reference gray scale value in the reference luminance band using a second gain value in the set luminance band with respect to the reference luminance band. The second gain value may denote a ratio between a gray scale value in a reference luminance band and a gray scale value in a set luminance band having a luminance the same as that of the gray scale value in the reference luminance band. The second gain value may be preset by comparing a 2.2 gamma curve in a corresponding luminance band with a 2.2 gamma curve in the reference luminance band. In addition, second gain values for each of the plurality of luminance bands may be stored in the memory 234. In one aspect, the second gain value may correspond to a DBV in each of the plurality of luminance bands and may be stored in the memory 234.

The mura compensation module 115 may obtain the second gain value for the set luminance band from the memory 234 and determine the second input gray scale value in the set luminance band that corresponds to the second reference gray scale value in the reference luminance band on the basis of the obtained second gain value.

In one aspect, the mura compensation module 115 may calculate the second input gray scale value in the set luminance band by multiplying the second reference gray scale value by the obtained second gain value.

Then, the mura compensation module 115 determines an input mura compensation value based on the first input gray scale value and the second input gray scale value (S1006).

Specifically, the mura compensation module 115 may determine the input mura compensation value in the set luminance band on the basis of the first input gray scale value and the second input gray scale value. In one aspect, the mura compensation module 115 may determine that a difference between the first input gray scale value and the second input gray scale value is the input mura compensation value for the first input gray scale value of the corresponding pixel.

Referring to FIG. 9 again, then, the display device 100 converts image data into image data in which the input mura compensation value is reflected (S905).

Specifically, the timing controller 116 of the display device 100 may generate the image data for which mura is compensated by reflecting the input mura compensation value of each of the plurality of pixels determined by the mura compensation module 115 to the image data received from the outside.

Then, the timing controller 116 of the display device 100 outputs the converted image data to the display panel 105 (S906). As the timing controller 116 of the display device 100 outputs the image data, in which the input mura compensation value is reflected, to the display panel 105, an image for which the mura is compensated is displayed on the display panel 105.

It will be understood by those skilled in the art that the present disclosure may be performed in other concrete forms without changing the technological scope and essential features.

In addition, methods described in the present specification may be at least partially implemented by using one or more computer programs or components. The components may be provided as a series of computer instructions through a computer-readable medium or machine-readable medium including a volatile or non-volatile memory. The instructions may be provided as software or firmware and entirely or partially implemented in hardware components such as application specific integrated circuits (ASICs), field programmable gate arrays (FPGAs), digital signal processors (DSPs), or other similar components. The instructions may be configured to be executed by one or more processors or other hardware components, and the processes or the other hardware components may perform all or some of methods and procedures disclosed in the present specification or allow them to be performed when executing the series of the computer instructions.

The present specification described above may not be limited to the above-described aspects and the accompanying drawings and may be clear to those skilled in the art that the present specification may be variously substituted, modified, and changed without departing from the technical spirit of the present specification. Therefore, it should be interpreted that the scope of the present disclosure is defined by the appended claims and encompasses all modifications or alterations derived from meanings, the scope, and equivalents of the appended claims.

1. A mura compensation module comprising:
a DBV setting unit configured to set one of a plurality of luminance bands to a set luminance band;
a memory configured to store reference a mura compensation value for each gray scale in a reference luminance band; and
a mura compensation value determination unit configured to determine an input mura compensation value of a first input gray scale value in the set luminance band on the basis of the reference mura compensation value for each gray scale in the reference luminance band.

2. The mura compensation module of claim 1, wherein the mura compensation value determination unit includes:
a reference gray scale value determination unit configured to determine a first reference gray scale value in the reference luminance band corresponding to the first input gray scale value in the set luminance band; and
a reference mura compensation value determination unit configured to obtain a reference mura compensation value for the first reference gray scale value from the memory.

3. The mura compensation module of claim 2, wherein:
the memory further stores a first gain value for each of the plurality of luminance bands; and
wherein the reference gray scale value determination unit obtains the first gain value for the set luminance band from the memory and determines the first reference gray scale value in the reference luminance band that corresponds to the first input gray scale value in the set luminance band on the basis of the obtained first gain value.

4. The mura compensation module of claim 3, wherein the first gain value denotes a ratio between a gray scale value in a corresponding luminance band and a gray scale value in the reference luminance band having a luminance the same as that of the gray scale value in the corresponding luminance band.

5. The mura compensation module of claim 1, wherein:
the mura compensation value determination unit includes an input mura compensation value determination unit configured to determine the input mura compensation value for the first input gray scale value in the set luminance band on the basis of a reference mura compensation value for a first reference gray scale value in the reference luminance band; and
wherein the first reference gray scale value in the reference luminance band has a luminance the same as that of the first input gray scale value in the set luminance band.

6. The mura compensation module of claim 5, wherein the input mura compensation value determination unit calculates a second reference gray scale value by reflecting the reference mura compensation value to the first reference gray scale value, determines a second input gray scale value in the set luminance band that corresponds to the second reference gray scale value in the reference luminance band, and determines the input mura compensation value for the first input gray scale value in the set luminance band on the basis of the first input gray scale value and the second input gray scale value.

7. The mura compensation module of claim 6, wherein:
the memory further stores second gain value for each of the plurality of luminance bands; and
wherein the input mura compensation value determination unit obtains the second gain value for the set luminance band from the memory and determines the second input gray scale value in the set luminance band that corresponds to the second reference gray scale value on the basis of the obtained second gain value.

8. The mura compensation module of claim 7, wherein the second gain value denotes a ratio between a gray scale value in the reference luminance band and a gray scale value in a corresponding luminance band having a luminance the same as that of the gray scale value in the reference luminance band.

9. The mura compensation module of claim 6, wherein the input mura compensation value determination unit determines a difference between the first input gray scale value and the second input gray scale value as the input mura compensation value for the first input gray scale value.

10. A display control apparatus comprising:
a pre-processor configured to generate gray scale data including a first input gray scale value for each of a plurality of pixels on the basis of image data;
a mura compensation module configured to determine an input mura compensation value of each of the plurality of pixels using a reference mura compensation value in a reference luminance band and the first input gray scale values of the plurality of pixels included in the gray scale data;
an image data conversion unit configured to convert the image data into image data in which the input mura compensation value is reflected with respect to each of the plurality of pixels; and
an image data output unit configured to output the converted image data.

11. The display control apparatus of claim 10, wherein the mura compensation module includes:
a DBV setting unit configured to set one of a plurality of luminance bands to a set luminance band and outputs a display brightness value corresponding to the set luminance band; and
a mura compensation value determination unit configured to determine an input mura compensation value of each of the plurality of pixels in the set luminance band using the display brightness value, the reference mura compensation value in the reference luminance band, and the first input gray scale values of the plurality of pixels included in the gray scale data.

12. The display control apparatus of claim 11, wherein:
the mura compensation value determination unit calculates first reference gray scale values in the reference luminance band by multiplying each of the first input gray scale values of the plurality of pixels by a first gain value corresponding to the display brightness value, and obtains a reference mura compensation value for each of the first reference gray scale values in the reference luminance band; and
wherein the first gain value denotes a ratio between a gray scale value in the set luminance band and a gray scale value in the reference luminance band having a luminance the same as that of the gray scale value in the set luminance band.

13. The display control apparatus of claim 11, wherein:
the mura compensation value determination unit calculates second input gray scale values in the set luminance band by multiplying each second reference gray scale value, in which the reference mura compensation value is reflected, in the reference luminance band by a second gain value corresponding to the display brightness value, and determines that a difference between the first input gray scale value and the second input gray scale value of each of the plurality of pixels is the input mura compensation value;, and
wherein the second gain value denotes a ratio between a gray scale value in the reference luminance band and a gray scale value in the set luminance band having a luminance the same as that of the gray scale value in the reference luminance band.

14. The display control apparatus of claim 10, wherein:
the mura compensation module includes a memory configured to store reference mura compensation value for each gray scale in the reference luminance band with respect to each of a plurality of blocks; and
wherein the plurality of pixels are divided into the plurality of blocks, and each of the plurality of blocks corresponds to at least one pixel.

15. A method of compensating for mura using a mura compensation module, comprising:
setting one of a plurality of luminance bands to a set luminance band;
obtaining a first input gray scale value for each of a plurality of pixels on the basis of image data;
determining a first reference gray scale value in a reference luminance band that corresponds to the first input gray scale value and obtaining a reference mura compensation value for the first reference gray scale value in the reference luminance band from a memory; and
determining an input mura compensation value for the first input gray scale value in the set luminance band using the reference mura compensation value.

16. The method of claim 15, wherein:
in the obtaining of the reference mura compensation value, a gray scale value in the reference luminance band having a luminance the same as that of the first input gray scale value in the set luminance band is determined to be the first reference gray scale value, and
wherein, in the determining of the second input gray scale value, a gray scale value in the set luminance band having a luminance the same as that of a second reference gray scale value in the reference luminance band is determined to be the second input gray scale value.

17. The method of claim 15, wherein:
the memory stores a reference mura compensation value for each gray scale in the reference luminance band with respect to each of a plurality of blocks, and
wherein the plurality of pixels is divided into the plurality of blocks, and each of the plurality of blocks corresponds to at least one pixel.

18. The method of claim 17, wherein, in the obtaining of the reference mura compensation value, a block corresponding to a corresponding pixel is searched for in the memory, and a reference mura compensation value for a first reference gray scale value of the retrieved block is obtained.

19. The method of claim 15, wherein the determining of the input mura compensation value includes:
calculating a second reference gray scale value in the reference luminance band by reflecting the obtained reference mura compensation value to the first reference gray scale value;
determining a second input gray scale value in the set luminance band that corresponds to a second reference gray scale value in the reference luminance band; and
determining an input mura compensation value for the first input gray scale value in the set luminance band on the basis of the first input gray scale value and the second input gray scale value.

20. The method of claim 19, wherein, in the determining of the input mura compensation value, a difference between the first input gray scale value and the second input gray scale value is determined to be the input mura compensation value for the first input gray scale value in the set luminance band.
